(19) United States
(12) Patent Application Publication
(10) Pub. No.: US 2025/0002068 A1
(43) Pub. Date: Jan. 2, 2025

(54) FOLDING JOINT AND CHILD CARRIER

(71) Applicant: WONDERLAND SWITZERLAND AG, Steinhausen (CH)

(72) Inventor: Haitao WU, Steinhausen (CH)

(21) Appl. No.: 18/703,649

(22) PCT Filed: Oct. 21, 2022
(86) PCT No.: PCT/EP2022/079456

§ 371 Date: Apr. 22, 2024

(30) Foreign Application Priority Data
Oct. 22, 2021 (CN) 202111235808.4

(51) Int. Cl. B62B 7/06

(52) U.S. Cl. CPC B62B 7/066; B62B 7/062

(57) ABSTRACT

A folding joint and a child carrier are provided. The folding joint includes a first holder body having a first accommodating cavity and a first engaging portion; a second holder body pivotally connected to the first holder body, and having a second accommodating cavity and a second engaging portion; a locking member having an unlocking position, and first and second locking positions; and an elastic member for applying a force to the locking member. When the locking member is in the first locking position or the second locking position, it is simultaneously engaged with the first engaging portion and the second engaging portion. An axial engaging depth of the locking member engaging with the second engaging portion is a first depth (L1) in the first locking position, which is greater than that in the second locking position.

### CROSS-REFERENCES TO RELATED APPLICATIONS

The present application claims a priority of Chinese Patent Application No. 202111235808.4, filed on Oct. 22, 2021, with the title of “FOLDING JOINT AND CHILD CARRIER”, the entire content of which is incorporated herein by reference.

### TECHNICAL FIELD

The present disclosure relates to the technical field of child carrier. More particularly, the present disclosure relates to a folding joint and a child carrier.

### BACKGROUND

A child stroller may facilitate outdoor activities for people carrying children. To facilitate storage and carry, the child stroller is generally designed to be foldable. In this way, the child stroller is in an unfolded state when being used. When the child stroller is not used, the child stroller can be folded for convenience of storage or carrying.

The conventional child stroller can be folded up not only through the front wheel support frame and the rear wheel support frame getting closer in a back-and-forth direction, but also through the handle frame and backrest frame getting closer in an up and down direction, so that the folded child stroller occupies a smaller space. A locking mechanism is generally provided between the handle frame and the backrest frame. The handle frame and the backrest frame are configured to pivot with respect to the locking mechanism to be folded or unfolded. The locking mechanism is adapted to lock the handle frame and backrest frame in a folded state or in an unfolded state. A lock releasing button operatively connected to the locking mechanism is generally provided on the handle frame. By operating the lock releasing button, a locking state of the relative positions between the handle frame and the backrest frame can be changed by a user through the locking mechanism, so that the handle frame and the backrest frame may can be either in the folded state or in the unfolded state.

### SUMMARY

The present disclosure intends to provide a folding joint for improving operation convenience of the folding joint, and a child carrier using the same.

In one aspect, the present disclosure provides a folding joint. The folding joint includes a first holder body having a first accommodating cavity, the first accommodating cavity being provided with a first engaging portion therein; a second holder body pivotally connected to the first holder body via a pivotal shaft, and having a second accommodating cavity, the second accommodating cavity being provided with a second engaging portion therein; a locking member installed in a space defined by the first accommodating cavity and the second accommodating cavity, and having an unlocking position, a first locking position, and a second locking position; and an elastic member disposed in the first accommodating cavity, and configured to apply an axial force to the locking member. When the locking member is in the unlocking position, the locking member retracts into the first accommodating cavity to engage with the first engaging portion so as to be separated from the second engaging portion, thereby allowing a relative rotation between the first holder body and the second holder body around the pivotal shaft. When the locking member is in the first locking position or the second locking position, the locking member is driven by the elastic member to partially protrude into the second accommodating cavity to be simultaneously engaged with the first engaging portion and the second engaging portion, so that the first holder body and the second holder body are locked in a first relative position or a second relative position. An axial engaging depth of the locking member engaging with the second engaging portion in the first locking position is defined as a first depth, and the axial engaging depth of the locking member engaging with the second engaging portion in the second locking position is defined as a second depth, and the second depth is less than the first depth.

In some embodiments according to the present disclosure, when the locking member is in the second locking position, an axial engaging depth of the locking member engaging with the first engaging portion may be a fourth depth, and the fourth depth is greater than the second depth.

In some embodiments according to the present disclosure, the second depth may be configured for, when a torque applied to the second holder body is greater than a predetermined value, allowing the second engaging portion to slip relative to the locking member.

In some embodiments according to the present disclosure, the second accommodating cavity may be provided with at least one pushing portion therein, and the locking member is provided with at least one interference-avoiding portion.

In some embodiments according to the present disclosure, when the locking member is in the first locking position, the at least one pushing portion may be in cooperation with the at least one interference-avoiding portion to allow the axial engaging depth of the locking member engaging with the second engaging portion to be the first depth; and when the locking member is in the second locking position, the at least one pushing portion may be pressed against an end face of the locking member, so as to restrict the axial engaging depth of the locking member engaging with the second engaging portion to be the second depth.

In some embodiments according to the present disclosure, the second accommodating cavity may be provided with at least two pushing portions arranged to be spaced apart from each other in a circumferential direction by a predetermined angle.

In some embodiments according to the present disclosure, the locking member may be sleeved on the pivotal shaft, and include first and second groups of teeth that are circumferentially arranged and spaced apart from each other, and a first connection portion and a second connection portion that are radially opposed to each other and located between the first group of teeth and the second group of teeth. The first engaging portion and the second engaging portion each include a plurality of engagement teeth to engage with the first group of teeth and the second group of teeth, wherein the at least one interference-avoiding portion may include a first interference-avoiding portion provided on the first connection portion, and the at least one pushing portion may include a first pushing portion that is in cooperation with the first interference-avoiding portion when the locking member is in the first locking position, and presses against an end face of the second connection portion when the locking member is in the second locking position.

In some embodiments according to the present disclosure, the first interference-avoiding portion may be a planar portion formed on the first connection portion, and the first pushing portion my include at least one protrusion extending axially from a bottom wall of the second accommodating cavity.

In some embodiments according to the present disclosure, the at least one interference-avoiding portion may further include a second interference-avoiding portion arranged at at least one circumferential end of the second connection portion, and the at least one pushing portion may further include a second pushing portion that is in cooperation with the second interference-avoiding portion when the locking member is in the first locking position, and presses against an end face of the first connection portion when the locking member is in the second locking position.

In some embodiments according to the present disclosure, the second interference-avoiding portion may be formed as a toothed groove, and the second pushing portion may be formed as a convex tooth.

In some embodiments according to the present disclosure, the folding joint may further include a lock releasing member operatively connected to the locking member to drive the locking member to switch to the unlocking position.

In some embodiments according to the present disclosure, the lock releasing member may be arranged between the locking member and the bottom wall of the second accommodating cavity, and the lock releasing member may have a slot hole to be sleeved on the pivotal shaft, wherein a guiding structure and a pushing structure are disposed between the lock releasing member and the bottom wall of the second accommodating cavity. The guiding structure may be configured to guide the lock releasing member to move in a radial direction perpendicular to the pivotal shaft, and the pushing structure may be configured to move the lock releasing member in an axial direction of the pivotal shaft when the lock releasing member moves in the radial direction.

In some embodiments according to the present disclosure, the folding joint further includes a pulling cable coupled to the lock releasing member to pull the lock releasing member to move in the radial direction.

In some embodiments according to the present disclosure, the pushing structure includes a pushing column extending axially from the bottom wall of the second accommodating cavity; and a pushing face formed on the lock releasing member and configured to abut against a free end of the pushing column.

In another aspect, the present disclosure further provides a child carrier. A stroller frame of the child carrier includes a first tube and a second tube, wherein the first tube and the second tube are joined by the folding joint described above.

In the folding joint provided by the present disclosure, when the locking member is in the second locking position, the engagement of the locking member with the second holder body is weaker than the engagement of the locking member with the first holder body. In this case, if it is necessary to change the relative position between the first holder body and the second holder body, a sufficient torque may be directly applied to the first holder body and/or the second holder body, so that the second engaging portion may slip with respect to the locking member, that is, the second holder body and the first holder body may be relatively rotated without additionally releasing the locking member, thereby simplifying the state transition operation of the folding joint.

### BRIEF DESCRIPTION OF THE DRAWINGS

FIG. 1 is a perspective view schematically illustrating a folding joint according to an embodiment of the present disclosure;

FIG. 2 is an exploded perspective view schematically illustrating the folding joint shown in FIG. 1:

FIG. 3 is a perspective view schematically illustrating a locking member in the folding joint according to an embodiment of the present disclosure:

FIG. 4 is a perspective view schematically illustrating a second holder body of the folding joint according to an embodiment of the present disclosure:

FIG. 5 is a cross-sectional view schematically illustrating the folding joint according to an embodiment of the present disclosure, in which various components of the folding joint are simplified so as to illustrate a relationship of relative positions of the locking member, the first holder body and the second holder body when the locking member is in an unlocking position:

FIG. 6 is a sectional view schematically illustrating the folding joint according to an embodiment of the present disclosure, in which the locking member is in a first locking position:

FIG. 7 is a cross-sectional view schematically illustrating the folding joint according to an embodiment of the present disclosure, in which various components of the folding joint are simplified so as to illustrate a relationship of relative positions of the locking member, the first holder body and the second holder body when the locking member is in the first locking position:

FIG. 8 is a perspective view schematically illustrating the second holder body, the locking member and an elastic member in the folding joint according to an embodiment of the present disclosure, in which the locking member is in a second locking position:

FIG. 9 is an axial cross-sectional view schematically illustrating the folding joint according to an embodiment of the present disclosure, in which various components of the folding joint are simplified so as to illustrate the relationship of the relative positions of the locking member, the first holder body and the second holder body when the locking member is in the second locking position:

FIG. 10 is a perspective view schematically illustrating a child carrier according to an embodiment of the present disclosure, in which the child carrier is in an unfolded state; and

FIG. 11 is a perspective view schematically illustrating the child carrier according to the embodiment of the present disclosure, in which the child carrier is in a folded state.

### ILLUSTRATIONS OF REFERENCE SIGNS

100. folding joint; 1. first holder body; 10. first accommodating cavity; 10c. central hole; 11. first engaging portion; 111. first group of engagement teeth; 112. second group of engagement teeth; 19. first arm; 2. second holder body; 20. second accommodating cavity; 20c. central hole; 201. bottom wall; 202. guiding side wall; 203. pushing column; 21. second engaging portion; 211. third group of engagement teeth; 212. fourth group of engagement teeth; 22. pushing portion; 221. first pushing portion; 222. second pushing portion; 29. second arm; 3. pivotal shaft; 4. locking member; 4a. end face; 4b. end face; 40c. central hole; 41. interference-avoiding portion; 411. first interference-avoiding portion; 412. second interference-avoiding portion; 421. first group of teeth; 422. second group of teeth; 423. first connection portion; 424. second connection portion; 5. elastic member; 6. lock releasing member; 60c. slot hole; 61. sliding wall; 62. pushing face; 7. pulling cable; 900. child carrier; 90. operating member; 91. first tube; 92. second tube; L1. first depth; L2. second depth; L3. third depth; L4. fourth depth.

### DETAILED DESCRIPTION OF THE EMBODIMENTS

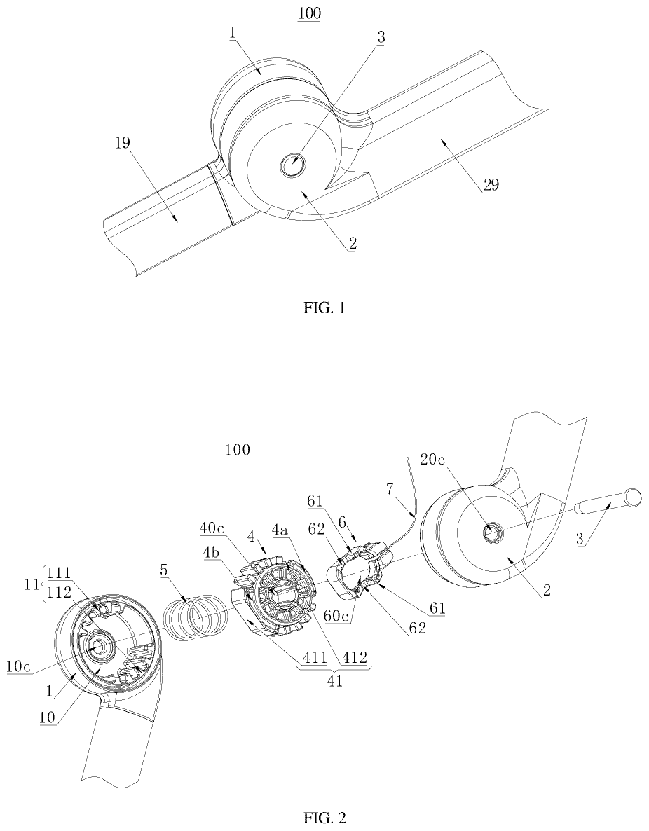

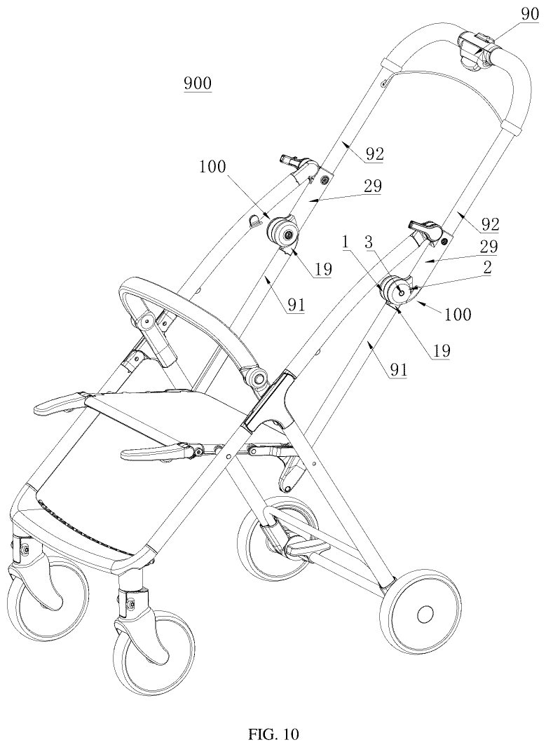

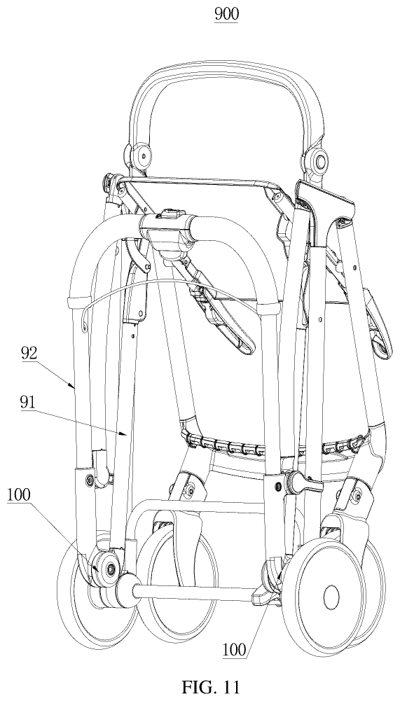

FIGS. 1 to 9 schematically illustrate the structure of a folding joint 100 according to an embodiment of the present disclosure, and FIGS. 10 and 11 illustrate a child carrier 900 (e.g., a child stroller) according to an embodiment of the present disclosure, in which the folding joint 100 according to an embodiment of the present disclosure is applied. It may be understood that the folding joint 100 provided in the embodiment of the present disclosure is not limited to be applied in the child carrier 900. Although the child carrier 900 in the embodiment of the present disclosure is described as, for example, a child stroller, the child carrier 900 may be other types of carriers, such as a child playard, a child hammock or the like.

Referring to FIGS. 1 and 2, the folding joint 100 may include a first holder body 1, a second holder body 2, a pivotal shaft 3, a locking member 4, and an elastic member 5. The first holder body 1 and the second holder body 2 are pivotally connected via the pivotal shaft 3. The first holder body 1 may be provided with a first arm 19 or be connected to the first arm 19, and the second holder body 2 may be provided with a second arm 29 or be connected to the second arm 29. The locking member 4 may be configured to lock the relative rotation between the first holder body 1 and the second holder body 2 or to release the rotational restriction between the first holder body 1 and the second holder body 2, so that the first arm 19 and the second arm 29 may rotate relative to each other as required or remain at a certain pivotal angle as required. The elastic member 5 is configured to apply a force on the locking member 4 so that the locking member 4 can be maintained at a locking position.

Referring to FIGS. 2, 4, and 5, in some embodiments according to the present disclosure, the first holder body 1 may have a first accommodating cavity 10, and a first engaging portion 11 may be arranged in the first accommodating cavity 10. The first engaging portion 11 includes, for example, a first group of engagement teeth 111 and a second group of engagement teeth 112 arranged at intervals in the circumferential direction. The quantities of engagement teeth included in each of the first group of engagement teeth 111 and the second group of engagement teeth 112 are not limited in the present disclosure. An end cover (if any) or an end face of the first holder body 1 may be provided with a central hole 10c for allowing the pivotal shaft 3 to pass therethrough. The second holder body 2 has, for example, a second accommodating cavity 20 in which a second engaging portion 21 may be provided. The second engaging portion 21 includes, for example, a third group of engagement teeth 211 and a fourth group of engagement teeth 212 arranged at intervals in the circumferential direction. The quantities of engagement teeth included in each of the third group of engagement teeth 211 and the fourth group of engagement teeth 212 are not limited in the present disclosure. An end cover (if any) or an end surface of the second holder body 2 may be provided with a central hole 20c for allowing the pivotal shaft 3 to pass therethrough. The first holder body 1 and the second holder body 2 are pivotally connected by the pivotal shaft 3 passing through the central holes 10c and 20c, such that the first accommodating cavity 10 and the second accommodating cavity 20 are coupled together.

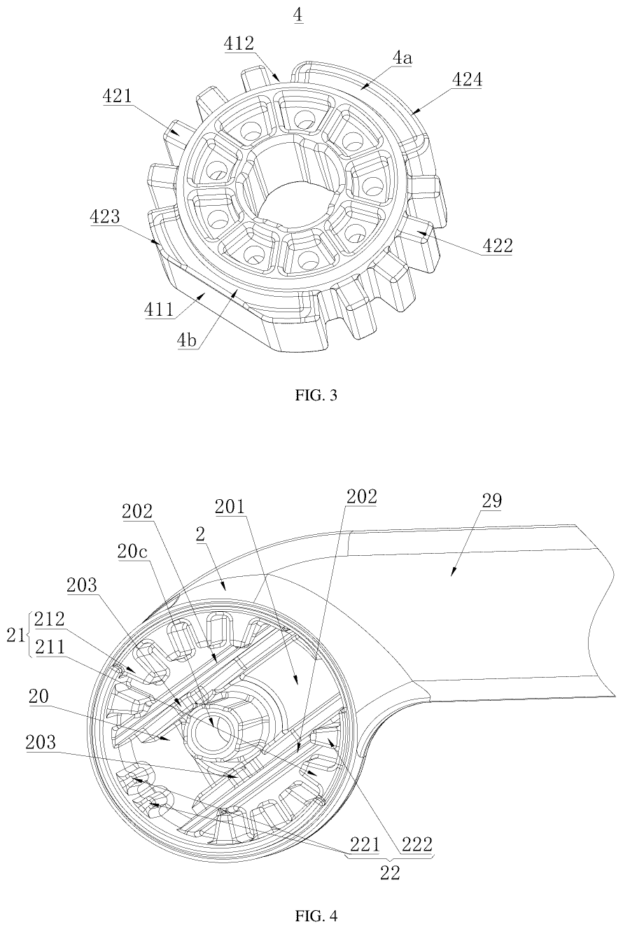

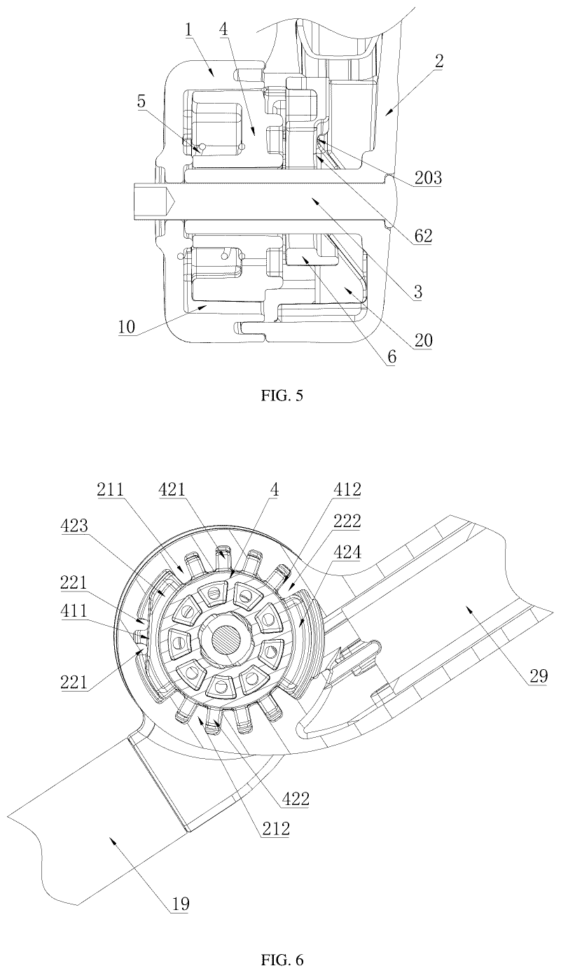

Referring to FIGS. 5, 7 and 9, it can be seen that the locking member 4 is installed in a space commonly defined by the first accommodating cavity 10 and the second accommodating cavity 20. Referring to FIG. 2, for example, the locking member 4 has a central hole 40c, and the pivotal shaft 3 may pass through the central hole 40c. Referring to FIG. 3, when the first engaging portion 11 and the second engaging portion 21 each have a toothed structure, the locking member 4 may correspondingly also be a toothed structure. For example, the locking member 4 includes a first group of teeth 421 and a second group of teeth 422 that are circumferentially spaced from each other, and includes a first connection portion 423 and a second connection portion 424 that are radially opposed to each other and arranged between the first group of teeth 421 and the second group of teeth 422. The first group of teeth 421 and the second group of teeth 422 are configured to engage with the first group of engagement teeth 111 and the second group of engagement teeth 112, respectively, so that relative rotation between the locking member 4 and the first holder body 1 can be prevented, while the first group of teeth 421 and the second group of teeth 422 slide axially with respect to the first group of engagement teeth 111 and the second group of engagement teeth 112. In addition, the first group of teeth 421 and the second group of teeth 422 are also configured to selectively engage with the third group of engagement teeth 211 and the fourth group of engagement teeth 212, and the first group of teeth 421 and the second group of teeth 422 are slidable in an axial direction with respect to the third group of engagement teeth 211 and the fourth group of engagement teeth 212.

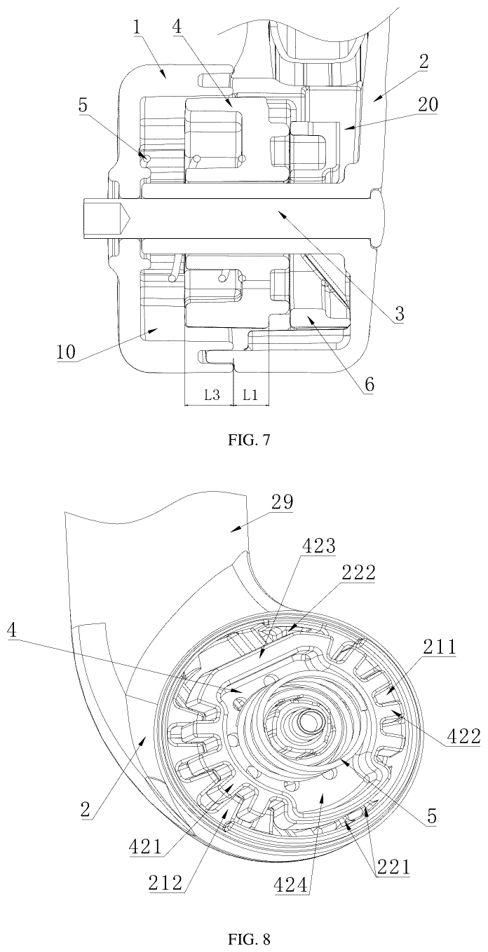

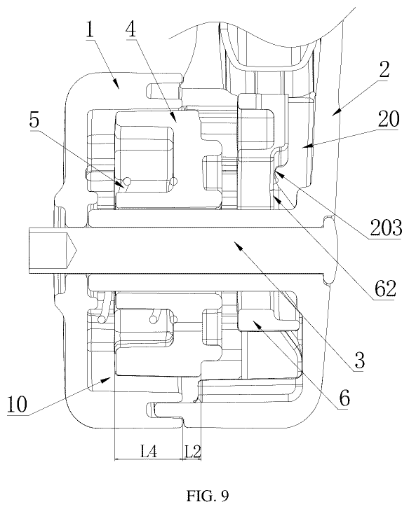

The locking member 4 may have an unlocking position shown in FIG. 5, a first locking position shown in FIG. 7, and a second locking position shown in FIG. 9. The elastic member 5 is disposed in the first accommodating cavity 10 and is configured to apply an axial force to the locking member 4 to maintain the locking member 4 in the first locking position or in the second locking position. The elastic member 5 may be, for example, a spring which may be sleeved on the pivotal shaft 3.

Referring to FIG. 5, when the locking member 4 is in the unlocking position, the elastic member 5 is compressed, the locking member 4 retracts into the first accommodating cavity 10, and the locking member 4 may be engaged with only the first engaging portion 11 while being separated from the second engaging portion 21. Accordingly, the first holder body 1 and the second holder body 2 may be relatively rotated around the pivotal shaft 3 for convenience of changing the positional relationship between the first arm 19 and the second arm 29.

Referring to FIG. 7, when the locking member 4 is in the first locking position, the locking member 4 is driven by the elastic member 5 and partially protrudes into the second accommodating cavity 20 to engage with both the first engaging portion 11 and the second engaging portion 21, thereby locking the first holder body 1 and the second holder body 2 in a first relative position. In some embodiments of the present disclosure, when the locking member 4 is in the first locking position, an axial engaging depth of locking member 4 engaging with the first engaging portion 11 is defined as a third depth L3, an axial engaging depth of locking member 4 engaging with the second engaging portion 21 is defined as a first depth L1, and the third depth L3 may be substantially equal to or greater than the first depth L1.

Referring to FIG. 9, when the locking member 4 is in the second locking position, the locking member 4 is driven by the elastic member 5 and partially protrudes into the second accommodating cavity 20 to engage with both the first engaging portion 11 and the second engaging portion 21, thereby locking the first holder body 1 and the second holder body 2 in a second relative position. In some embodiments of the present disclosure, when the locking member 4 is in the second locking position, the axial engaging depth of the locking member 4 engaging with the first engaging portion 11 is defined as a fourth depth L4, the axial engaging depth of the locking member 4 engaging with the second engaging portion 21 is defined as a second depth L2, and the fourth depth L4 is much larger than the second depth L2. It should be noted that the second depth L2 is smaller than the above-mentioned first depth L1. In some embodiments of the present disclosure, the second depth L2 is configured for allowing the second engaging portion 21 to slip relative to the locking member 4 when the torque applied to the second holder body 2 is greater than a predetermined value.

As mentioned above, when the locking member 4 is in first locking position, the engagement of the locking member 4 with the first holder body 1 and the second holder body 2 is relatively stable. In this situation, when the relative position of the first holder body 1 and the second holder body 2 is required to be changed, the locking member 4 needs to be moved to the unlocking position, so that the relative position of the first holder body 1 and the second holder body 2 can be changed. When the locking member 4 is in the second locking position, the engagement of the locking member 4 with the second holder body 2 is weaker than the engagement of the locking member 4 with the first holder body 1. In this case, if the relative position of the first holder body 1 and the second holder body 2 is required to be changed, it is not necessary for the locking member 4 to be in the unlocking position. Instead, a sufficient torque can be directly applied to the first holder body 1 and/or the second holder body 2, such that the second engaging portion 21 slips with respect to the locking member 4, and thus the second holder body 2 and the first holder body 1 may be relatively rotated. Since the locking member 4 allows the relative positions of the first holder body 1 and the second holder body 2 to be changed without a lock releasing operation on the locking member 4 in advance when the locking member 4 is in the second locking position, the state transition operation of the folding joint is simplified.

It should be noted that although in the above-mentioned example, the locking member 4 is engaged with the first engaging portion 11 and the second engaging portion 21 by a tooth engagement, it can be understood that in other embodiments, the locking member 4 can be engaged with the first engaging portion 11 and the second engaging portion 21 by other manners. For example, the locking member 4 can be engaged with the first engaging portion 11 and the second engaging portion 21 by means of a key engagement.

In some embodiments of the present disclosure, the product (e.g., the child carrier) that includes the folding joint 100 may have a stable unfolded state and a relatively stable folded state. For example, when the product is in the unfolded state, which corresponds to a normal-use state of the product. When the product is in the folded state, it is adapted for convenience of carrying or storing the product. The first locking position of the locking member 4 may correspond to the unfolded state of the product, and the second locking position of the locking member 4 may correspond to the folded state of the product. In this way, when the product is in use, if it is necessary to change the product to be in a folded state, the locking member 4 has to be operated to allow the product to be folded, which can effectively prevent undesirable consequences due to an accidental folding of the product. When the product is in the folded state, the user can quickly change the product from the folded state to the unfolded state by pulling the first arm 19 and/or the second arm 29 by applying a force without additionally operating the locking member 4, thereby simplifying the operation of the product from the folded state to the unfolded state.

Reference is made to FIGS. 2 to 4. A solution is provided for maintaining the locking member 4 in the first locking position or the second locking position. For example, at least one pushing portion 22 may be provided in the second accommodating cavity 20, and at least one interference-avoiding portion 41 corresponding to the at least one pushing portion 22 may be provided on the locking member 4. When the locking member 4 is in the first locking position, the relative position of first holder body 1 and second holder body 2 satisfies the following condition; the pushing portion 22 is in cooperation with the interference-avoiding portion 41 to allow the axial engaging depth of the locking member 4 engaging with the second engaging portion 21 to reach the first depth L1. Meanwhile, the interference-avoiding portion 41 provides the pushing portion 22 with an axially movable space, so that the locking member 4 does not suffer from an axial resistance from the pushing portion 22 while the lock member 4 is protruding into the second accommodating cavity 20 under the driving of the elastic member 5. When the locking member 4 is in the second locking position, in order to allow the second holder body 2 and the first holder body 1 to rotate with respect to each other, the relative position of the first holder body 1 and the second holder body 2 may satisfy the following conditions: the interference-avoiding portion 41 and the pushing portion 22 are offset in the circumferential direction. While the locking member 4 is protruding into the second accommodating cavity 20 under the driving of elastic member 5, the pushing portion 22 presses against the end face of the locking member 4 to restrict the locking member 4 from further protruding into the second accommodating cavity 20, thereby restricting the axial engaging depth of the locking member 4 engaging with the second engaging portion 21 to be the second depth L2.

It should be understood that there may be various embodiments in which the quantities and/or shapes of the pushing portion 22 and the interference-avoiding portion 41 may be different. In some embodiments of the present disclosure, at least two pushing portions 22 may be provided in the second accommodating cavity 20 which are spaced apart from each other and arranged to form a predetermined angle in the circumferential direction. When the locking member 4 is in the second locking position, the at least two pushing portions 22 may provide more balanced support for the locking member 4.

Referring to FIGS. 3 and 4, and FIGS. 6 and 9, at least one interference-avoiding portion 41 may include a first interference-avoiding portion 411 provided on the first connection portion 423, which can be, for example, a planar portion formed on the first connection portion 423. The at least one pushing portion 22 may include a first pushing portion 221, which may include, for example, at least one protrusion extending axially from the bottom wall 201 of the second accommodating cavity 20. In the present embodiment, the first pushing portion 221 includes, for example, two adjacent toothed protrusions. In addition, the at least one interference-avoiding portion 41 may further include, for example, a second interference-avoiding portion 412 that is formed on at least one circumferential end of the second connection portion 424. The second interference-avoiding portion 412 may be, for example, a toothed groove. The at least one pushing portion 22 may also include, for example, a second pushing portion 222, which may be, for example, a convex tooth adjacent to third group of engagement teeth 211 and/or the fourth group of engagement teeth 212.

Referring to FIG. 6, the first pushing portion 221 and the second pushing portion 222 cooperate with the first interference-avoiding portion 411 and the second interference-avoiding portion 412, respectively, when the locking member 4 is in the first locking position. Specifically, the first pushing portion 221 is in the space left by the first interference-avoiding portion 411, the second pushing portion 222 is in the space left by the second interference-avoiding portion 412, and the first pushing portion 221 and the second pushing portion 222 do not exert a force to the locking member 4. Additionally, the first group of engagement teeth 111 and the third group of engagement teeth 211 are engaged with the first group of teeth 421. The second group of engagement teeth 112 and the fourth group of engagement teeth 212 are engaged with the second group of teeth 422. Referring to FIG. 7, the locking member 4 moves from the first accommodating cavity 10 to the second accommodating cavity 20 under the resilience of the elastic member 5, and the engagement depth between the locking member 4 and the second engaging portion 21 reaches the first depth L1.

Referring to FIGS. 3 and 8, when the locking member 4 is in the second locking position, the first pushing portion 221 presses an end face 4a of the second connection portion 424, and the second pushing portion 222 presses an end face 4b of the first connection portion 423. In addition, the first group of engagement teeth 111 and the fourth group of engagement teeth 212 are engaged with the first group of teeth 421, and the second group of engagement teeth 112 and third group of engagement teeth 211 are engaged with the second group of teeth 422. Referring to FIG. 9, the engagement depth of the locking member 4 that is engaged with the second engaging portion 21 is restricted to be the second depth L2 under the action of the elastic member 5, the first pushing portion 221, and the second pushing portion 222.

It should be understood that the embodiments of the pushing portion 22 and the interference-avoiding portion 41 are not limited to the above-mentioned examples, as long as the engagement depth of the locking member 4 engaging with second engaging portion 21 in the second locking position less than the engagement depth of the locking member 4 engaging with the second engaging portion 21 in the first locking position so that the relative rotation between the first holder body 1 and the second holder body 2 without additionally operating the locking member 4 is achieved.

Referring to FIGS. 2, 5, 7 and 9, an implementation for releasing the locking member 4 is also shown in this embodiment. The folding joint 100 may further include a lock releasing member 6 operatively connected to the locking member 4 to drive the locking member 4 to move to the unlocking position. For example, in some embodiments of the present disclosure, the lock releasing member 6 may be located in the second accommodating cavity 20 and between the locking member 4 and the bottom wall 201 of the second accommodating cavity 20. The lock releasing member 6 may have a slot hole 60c to be sleeved on the pivotal shaft 3. Furthermore, the movement of the lock releasing member 6 is assisted by a guiding structure and a pushing structure. In one embodiment, the guiding structure and the pushing structure may be provided between the lock releasing member 6 and the bottom wall 201 of the second accommodating cavity 20. The guiding structure is configured to guide the lock releasing member 6 to move in a radial direction perpendicular to the pivotal shaft 3, and the lock releasing member 6 may be moved in the radial direction, for example, by pulling a pulling cable 7 connected to the lock releasing member 6. The pushing structure is configured to, when the lock releasing member 6 is moved in the radial direction, move the lock releasing member 6 in the axial direction of the pivotal shaft 3, so that the lock releasing member 6 may apply a lock releasing pressure to or not to the locking member 4.

Referring to FIGS. 2 and 4, in some embodiments of the present disclosure, the guiding structure may include two guiding side walls 202 parallelly arranged and two sliding walls 61 parallelly arranged. The guiding side walls 202 are formed in the second accommodating cavity 20, and the sliding walls 61 are formed on the wall of the lock releasing member 6 and configured to be respectively slidably engaged with the two guiding side walls 202 so as to guide the lock releasing member 6 to move in the radial direction.

Referring to FIGS. 2, 5, 7 and 9, in some embodiments of the present disclosure, the pushing structure may include a pushing column 203 and a pushing face 62. The pushing column 203 extends axially, for example, from the bottom wall 201 of the second accommodating cavity 20. The pushing face 62 is formed on the lock releasing member 6, and is configured to abut against a free end of the pushing column 203. In this way, when the lock releasing member 6 is moved in the radial direction by pulling the pulling cable 7, the lock releasing member 6 may push the locking member 4 to resist the elastic force of the elastic member 5 by means of the cooperation between the pushing face 62 and the pushing column 203, so that the locking member 4 switches to the unlocking position. When the tensile force of the pulling cable 7 exerted on the lock releasing member 6 is released, the elastic member 5 exerts a force on the lock releasing member 6 through the locking member 4, and the lock releasing member 6 is returned through the cooperation of the pushing face 62 and the pushing column 203.

It should be understood that in other embodiments of the present disclosure, the lock releasing member 6 may have different structure or mechanism, as long as the lock releasing member 6 is capable of releasing the lock of the locking member 4 according to practical requirements and does not affect the lock of the locking member 4, and such other implementations are not detailed exemplified herein. In addition, a solution in which the locking member 4 is released by operating the lock releasing member 6 via the pulling cable 7 is also involved in the prior art, and details thereof are omitted herein.

Referring to FIGS. 10 and 11, a child carrier 900 provided in accordance with an embodiment of the present disclosure is shown. The child carrier 900 may be, for example, a child stroller, and the stroller frame of the child stroller includes a first tube 91 and a second tube 92. The first tube 91 may be, for example, a lower supporting tube, and the second tube 92 may be, for example, a handle tube. The first tube 91 and the second tube 92 are joined by the folding joint 100 described above. The first tube 91 is connected to the first holder body 1, and the second tube 92 is connected to the second holder body 2. Specifically, the first tube 91 may be sleeved with the first arm 19, and the second tube 92 may be sleeved with the second arm 29. An operating member 90 may also be provided on the second tube 92, and the user may press the operating member 90 to release the lock of the locking member 4. For example, in some embodiments of the present disclosure, when the user presses the operating member 90, the pulling cable 7 may be pulled so that the locking member 4 is released by the lock releasing member 6.

According to the abovementioned description, when the child stroller is in the unfolded state as shown in FIG. 10, the locking member 4 is in the first locking position, and it is not easy for the child stroller to be accidentally folded due to an external force. After the user presses the operating member 90 to release the locking member 4, the child stroller may be folded up into the folded state as shown in FIG. 11, in which the locking member 4 is in the second locking position for convenience of storage and transportation of the child stroller. When the child stroller needs to be unfolded again, the user may directly pull the handle tube without pressing the operating member 90, so that the stroller frame may be conveniently opened.

In some embodiments of the present disclosure, the pushing portion 22 of the folding joint 100 that is applied in the child stroller is 0.6 mm˜1 mm lower, for example, than the third group of engagement teeth 211 and the fourth group of engagement teeth 212. Accordingly, the second depth L2 may fall within the range of 0.6 mm˜1 mm. As such, when the locking member 4 is in the second locking position, the engagement of the locking member 4 with the second holder body 2 may not only prevent the stroller frame from being accidentally unfolded, but also ensure that the stroller frame can be directly unfolded when being subjected to a large torque.

Each of the technical features in the above-described embodiments may be combined arbitrarily. For the sake of brevity, not all possible combinations of each technical features in the above-described embodiments are described. However, the combinations of these technical features should be considered to be within the scope of the present description as long as they do not contradict each other.

The above-described embodiments represent only a few embodiments of the present disclosure, and the description is more specific and detailed, but shall not therefore to be construed as limiting the scope of the present application. It should be noted that various variations and modifications may be made to those skilled in the art without departing from the concept of the present disclosure, all of which fall within the scope of the present disclosure. Accordingly, the protection scopes of the present invention patent should be governed by the appended claims.

1. A folding joint comprising:
a first holder body;
a second holder body pivotally connected to the first holder body around an axial direction; and
a locking member a first locking position and a second locking position,
wherein when the locking member is in the first locking position or the second locking position, the locking member is simultaneously engaged with the first holder body and the second holder body, and
wherein an axial engaging depth of the locking member engaging with the second holder body when the locking member is in the first locking position is defined as a first depth, the axial engaging depth of the locking member engaging with the second holder body when the locking position is in the second locking position in the second locking position is defined as a second depth, and the second depth is less than the first depth.

2. The folding joint according to claim 1, wherein when the locking member is in the second locking position, an axial engaging depth of the locking member engaging with the first holder body is a fourth depth, and the fourth depth is greater than the second depth.

3. The folding joint according to claim 1, wherein the second depth is configured for, when a torque applied to the second holder body is greater than a predetermined value, allowing the second holder body to slip relative to the locking member.

4. The folding joint according to claim 1, wherein the second holder body is provided with at least one pushing portion therein, and the locking member is provided with at least one interference-avoiding portion,
wherein when the locking member is in the first locking position, the at least one pushing portion is in cooperation with the at least one interference-avoiding portion to allow the axial engaging depth of the locking member engaging with the second holder body to be the first depth, and
wherein when the locking member is in the second locking position, the at least one pushing portion is pressed against an end face of the locking member, so as to restrict the axial engaging depth of the locking member engaging with the second holder body to be the second depth.

5. The folding joint according to claim 4, wherein the second holder body is provided with at least two pushing portions arranged to be spaced apart from each other in a circumferential direction by a predetermined angle.

6. The folding joint according to claim 4, wherein the locking member comprises a first connection portion and a second connection portion that are radially opposed to each other, and
wherein the at least one interference-avoiding portion comprises a first interference-avoiding portion provided on the first connection portion, and the at least one pushing portion comprises a first pushing portion that is in cooperation with the first interference-avoiding portion when the locking member is in the first locking position, and presses against an end face of the second connection portion when the locking member is in the second locking position.

7. The folding joint according to claim 6, wherein the first interference-avoiding portion is a planar portion formed on the first connection portion, and the first pushing portion comprises at least one protrusion extending axially.

8. The folding joint according to claim 6, wherein the at least one interference-avoiding portion further comprises a second interference-avoiding portion arranged at at least one circumferential end of the second connection portion, and the at least one pushing portion further comprises a second pushing portion that is in cooperation with the second interference-avoiding portion when the locking member is in the first locking position, and presses against an end face of the first connection portion when the locking member is in the second locking position.

9. The folding joint according to claim 8, wherein the second interference-avoiding portion is formed as a toothed groove, and the second pushing portion is formed as a convex tooth.

10. The folding joint according to claim 1, wherein the locking member further comprises an unlocking position, and when the locking member is in the unlocking position, the locking member retracts into the first holder body to engage with the first holder body so as to be disengaged from the second holder body, thereby allowing a relative rotation between the first holder body and the second holder body around the axial direction.

11. The folding joint according to claim 15, wherein
the lock releasing member is arranged between the locking member and the second holder body, and
wherein a guiding structure and a pushing structure are disposed between the lock releasing member and the second holder body, the guiding structure is configured to guide the lock releasing member to move in a radial direction perpendicular to the axial direction, and the pushing structure is configured to move the lock releasing member in the axial direction when the lock releasing member moves in the radial direction.

12. The folding joint according to claim 11, further comprising a pulling cable coupled to the lock releasing member to pull the lock releasing member to move in the radial direction.

13. The folding joint according to claim 11, wherein the pushing structure comprises:
a pushing column extending axially from the second holder body; and
a pushing face formed on the lock releasing member and configured to abut against a free end of the pushing column.

14. A child carrier comprising a stroller frame including a first tube and a second tube, wherein the first tube and the second tube are joined by the folding joint according to claim 1.

15. The folding joint according to claim 10, wherein the folding joint further comprises a lock releasing member operatively connected to the locking member to drive the locking member to switch to the unlocking position.

16. The folding joint according to claim 1, wherein the first holder body has a first accommodating cavity, the first accommodating cavity is provided with a first engaging portion therein, the second holder body has a second accommodating cavity, the second accommodating cavity is provided with a second engaging portion therein, and the locking member is installed in the space defined by the first accommodating cavity, and engages with the second engaging portion when the locking member is in the first locking portion or in the second locking portion.

17. The folding joint according to claim 16, wherein the folding joint further comprises an elastic member disposed in the first accommodating cavity and configured to apply an axial force to the locking member, and wherein when the locking member is in the first locking position or the second locking position, the locking member is driven by the elastic member to partially protrude into the second accommodating cavity to be simultaneously engaged with the first engaging portion and the second engaging portion, so that the first holder body and the second holder body is locked in a first relative position or a second relative position.

18. The folding joint according to claim 1, wherein the second depth is in the range of 0.6 mm˜1 mm.

19. The folding joint according to claim 6, wherein the locking member comprises a first group of teeth and a second group of teeth that are circumferentially arranged and spaced apart from each other, and are located between the first connection portion and the second connection portion, the second holder body include a plurality of engagement teeth to engage with the first group of teeth and the second group of teeth, and the pushing portion of the second holder body is lower than the plurality of engagement teeth of the second holder body.

20. The folding joint according to claim 6, wherein the locking member comprises a first group of teeth and a second group of teeth that are circumferentially arranged and spaced apart from each other, and are located between the first connection portion and the second connection portion,
wherein the first holder body includes a first group of engagement teeth and a second group of engagement teeth that are circumferentially arranged and spaced apart from each other, the second holder body includes a third group of engagement teeth and a fourth group of engagement teeth that are circumferentially arranged and spaced apart from each other, and the first pushing portion is located between the third group of engagement teeth and a fourth group of engagement teeth,
wherein when the locking member is in the first locking position, the first and third groups of engagement teeth engage with the first group of teeth while the second and fourth groups of engagement teeth engage with the second group of teeth, and
wherein when the locking member is in the second locking position, the first and fourth groups of engagement teeth engage with the first group of teeth while the second and third groups of engagement teeth engage with the second group of teeth.

20. A child carrier comprising a stroller frame including a first tube and a second tube, wherein the first tube and the second tube are joined by the folding joint according to claim 1.
